(19) United States
(12) Patent Application Publication
(10) Pub. No.: US 2011/0280335 A1
(43) Pub. Date: Nov. 17, 2011

(54) METHOD FOR MULTI-CHANNEL TRANSMISSION WITH MULTIPLE FREQUENCY SEGMENTS

(75) Inventors: YUNG SZU TU, HSINCHU COUNTY (TW); YEN CHIN LIAO, HSINCHU COUNTY (TW); CHENG HSUAN WU, HSINCHU COUNTY (TW); CHIH KUN CHANG, HSINCHU COUNTY (TW)

(73) Assignee: RALINK TECHNOLOGY CORPORATION, HSINCHU COUNTY (TW)

(21) Appl. No.: 13/025,786

(22) Filed: Feb. 11, 2011

Related U.S. Application Data
(60) Provisional application No. 61/345,090, filed on May 15, 2010.

(51) Int. Cl. H04L 27/00

(52) U.S. Cl. 375/295

(57) ABSTRACT

A method for multi-channel transmission with multiple frequency segments comprises the steps of: determining a plurality of non-contiguous frequency segments from an available frequency band of a communication system, wherein each frequency segment comprises a plurality of contiguous channels; determining available channels from the channels in the plurality of non-contiguous frequency segments, wherein the number of available channels is less than or equal to the number of total channels in the plurality of non-contiguous frequency segments; determining a primary channel from the available channels; performing channel bonding technique on the available channels; and performing multi-channel transmission by performing dynamic channel selection technique on the available channels.

### BACKGROUND OF THE INVENTION

1. Field of the Invention

The present invention relates to a method for multi-channel transmission with multiple frequency segments.

2. Description of the Related Art

Wireless local area network (WLAN) technology is widely established to provide access to the Internet with mobile devices. Conventionally, a typical WLAN communication system may use a transmission bandwidth of 20 MHz or 40 MHz. To achieve a higher throughput in WLAN communication systems, the next-generation WLAN needs to provide increased the signal bandwidth above 40 MHz. However, as WLAN technology becomes more popular and widely accepted, the spectrum occupied by WLAN communication systems is becoming more crowded. As a result, it is increasingly likely that a continuous spectrum of more than 40 MHz bandwidth is not available. Hence, there's a need to provide a method to solve the problem when a consecutive spectrum of more than 40 MHz bandwidth is not available.

Some methods are proposed to transmit signals at non-contiguous bands with a total bandwidth of 80 MHz. For example, an 80 MHz transmission bandwidth can be achieved by employing two frequency segments, each with bandwidth of 40 MHz and containing two channels of 20 MHz. However, if either frequency segment contains a busy channel, such frequency segment is then not available as a candidate for data transmission. Accordingly, if two consecutive idle channels do not exist, such method cannot be applied.

### SUMMARY OF THE INVENTION

The method for multi-channel transmission with multiple frequency segments according to one embodiment of the present invention comprises the steps of: determining a plurality of non-contiguous frequency segments from an available frequency band of a communication system, wherein each frequency segment comprises a plurality of contiguous channels; determining available channels from the channels in the plurality of non-contiguous frequency segments, wherein the number of the available channels is less than or equal to the number of the total channels in the plurality of non-contiguous frequency segments; determining a primary channel from the available channels; performing channel bonding technique on the available channels; and performing multi-channel transmission by performing dynamic channel selection technique on the available channels.

The method for multi-channel transmission with multiple frequency segments according to another embodiment of the present invention comprises the steps of: evaluating status of a plurality of available channels, wherein the plurality of available channels are grouped in different non-contiguous frequency segments, and the number of available channels is less than or equal to the number of total channels contained in the non-contiguous frequency segments; performing multi-channel transmission by performing dynamic channel selection technique on the available channels; deferring the multi-channel transmission if an idle duration of the primary channel is less than a first idle time; deferring the multi-channel transmission if an idle duration of any other channel in the frequency segment containing the primary channel is less than a second idle time; and exempting the multi-channel transmission of a frequency segment other than the frequency segment containing the primary channel if an idle duration of a channel in the frequency segment is less than a second idle time.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows the flowchart of the method for multi-channel transmission with multiple frequency segments according to an embodiment of the present invention;

FIG. 2 shows the available frequency band of a communication system according to an embodiment of the present invention;

FIG. 3 shows the partial flowchart of the method for multi-channel transmission with multiple frequency segments according to an embodiment of the present invention; and

FIG. 4 shows the operation of dynamic channel selection according to an embodiment of the present invention.

### DETAILED DESCRIPTION OF THE INVENTION

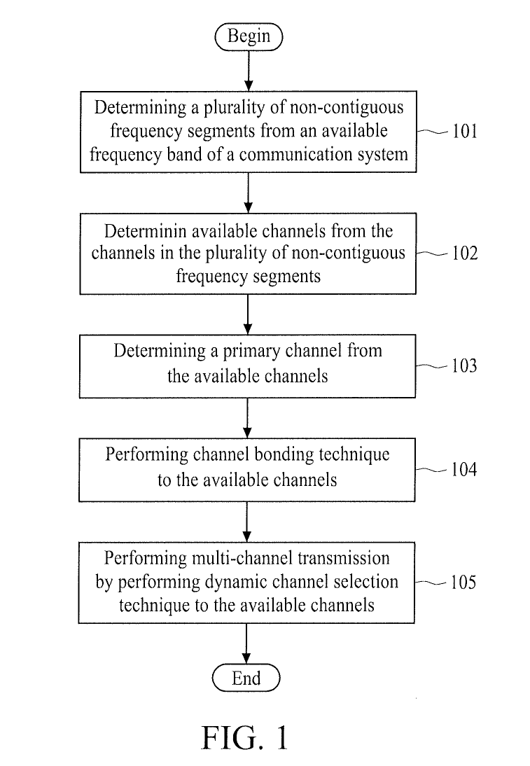

FIG. 1 shows the flowchart of the method for multi-channel transmission with multiple frequency segments according to an embodiment of the present invention. In step 101, a plurality of non-contiguous frequency segments from an available frequency band of a communication system are determined, wherein each frequency segment comprises a plurality of contiguous channels, and step 102 is executed. In step 102, available channels from the channels in the plurality of non-contiguous frequency segments are determined, wherein the number of available channels is less than or equal to the number of the total channels in the plurality of non-contiguous frequency segments, and step 103 is executed. In step 103, a primary channel is determined from the available channels, and step 104 is executed. In step 104, a channel bonding technique is performed on the available channels, and step 105 is executed. In step 105, multi-channel transmission is performed by performing dynamic channel selection technique on the available channels.

The following illustrates applying the method shown in FIG. 1 to a communication system according to an embodiment of the present invention. In this communication system, the maximum allowable signal bandwidth is B MHz, and the signal spectrum can be divided into several channels according to the signal specification. In addition, there are a total of S intermediate frequency (IF) circuit blocks in the communication circuit performing the signal processing for the communication system, wherein each IF circuit block can handle the signal processing for a frequency segment. Accordingly, in step 101, a total of S non-contiguous frequency segments are determined. The bandwidth of a channel is CB MHz. Accordingly, B is an integer multiple of CB. The bandwidth of each frequency segment is IFB(s), wherein s=1 to S. In other words, each frequency segment has C(s) channels, wherein C(s)=IFB(s)/CB. The channel in the s^{th} I frequency segment is denoted as SC(s,c), wherein s=1 to S and c=1 to C(s).

In step 102, available channels from the channels in the plurality of non-contiguous frequency segments are determined, wherein the step can be performed at the association stage of the communication system. These channels don't have to be contiguous. The set of the available channels in the s^{th} segment is denoted as ChS(s), wherein the value of the element in ChS(s) ranges from 1 to C(s). In addition, the summation of the sizes of all ChS(s) cannot be greater than B/CB, i.e.

$${\sum }_{s = 1}^{S} \vert ChS ( s ) \vert \leq \frac{B}{CB} .$$

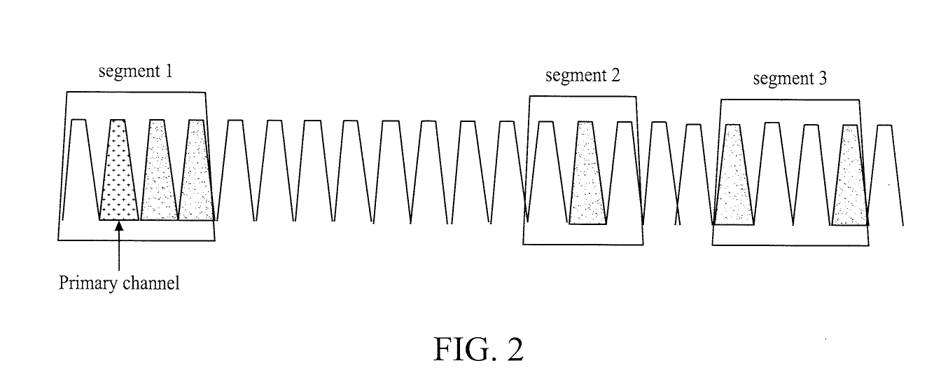

FIG. 2 shows the available frequency band of a communication system according to an embodiment of the present invention. In this communication system, the number of non-contiguous frequency segments, S, is three. The bandwidth of each channel, CB, is 20 MHz. As shown in FIG. 2, the bandwidths of the frequency segments are IFB(1)=80, IFB(2)=60 and IFB(3)=80. Accordingly, it can be deduced that C(1)=4, C(2)=3 and C(3)=4. The sets of the available channels are respectively ChS(1)={SC(1,2), SC(1,3), SC(1,4)}, ChS(2)={SC(2,2)}, and ChS(3)={SC(3 μl), SC(3,4)}. In addition, the bandwidth of each frequency segment is more than 40 MHz.

In step 103, a primary channel is determined from the available channels. Accordingly, the channel SC(1,2) is determined as the primary channel as shown in FIG. 2. In step 104, a channel bonding technique is performed on the available channels. Accordingly, the sets of the available channels are then bonded together for multi-channel transmission.

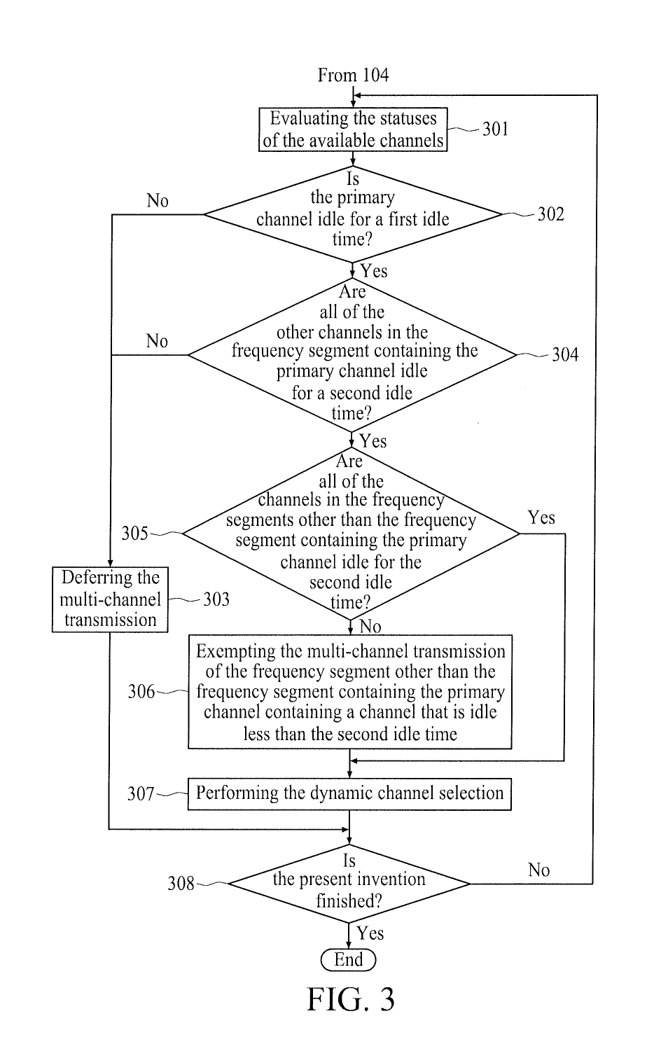

In step 105, multi-channel transmission is performed by performing dynamic channel selection technique on the available channels. FIG. 3 shows a flowchart of the sub-steps of the step 105 shown in FIG. 1. In step 301, the statuses of the available channels are evaluated, and step 302 is executed. In step 302, it is checked whether the primary channel is idle for a first idle time. If the primary channel is idle for a first idle time, step 304 is executed; otherwise, step 303 is executed. In step 303, the multi-channel transmission is deferred, and step 308 is executed. In step 304, it is checked whether all of the other channels in the frequency segment containing the primary channel are idle for a second idle time. If all of the other channels in the frequency segment containing the primary channel are idle for a second idle time, step 305 is executed; otherwise, step 303 is executed. In step 305, it is checked whether all of the channels in the frequency segments other than the frequency segment containing the primary channel are idle for the second idle time. If all of the channels in the frequency segments other than the frequency segment containing the primary channel are idle for a second idle time, step 307 is executed; otherwise, step 306 is executed. In step 306, the frequency segment other than the frequency segment containing the primary channel containing a channel that is idle less than the second idle time is exempt from the multi-channel transmission. In step 307, the dynamic channel selection is performed, and step 308 is executed. In step 308, it is determined whether the present invention is finished. If it is determined that the present invention is not finished, step 301 is executed.

Following the method shown in FIG. 3, when there is a signal to be transmitted, the statuses of all channels are evaluated. If there is any channel ChS(s) of the s^{th} segment not idle for duration of the second idle time at the start of transmission, the s^{th} segment is exempt from signal transmission. If the primary channel has not been idle for duration of the first idle time or other channels in the same frequency segment as the primary channel is not idle for duration of the first idle time, the signal transmission is deferred. Accordingly, transmitting signal with many signal bandwidths can be achieved with only two frequency segments because the set of the available channels in each frequency segment doesn't have to be equal to the number of total channels in each segment, i.e.

$${\sum }_{s = 1}^{S} \vert ChS ( s ) \vert \leq {\sum }_{s = 1}^{S} C ( s ) .$$

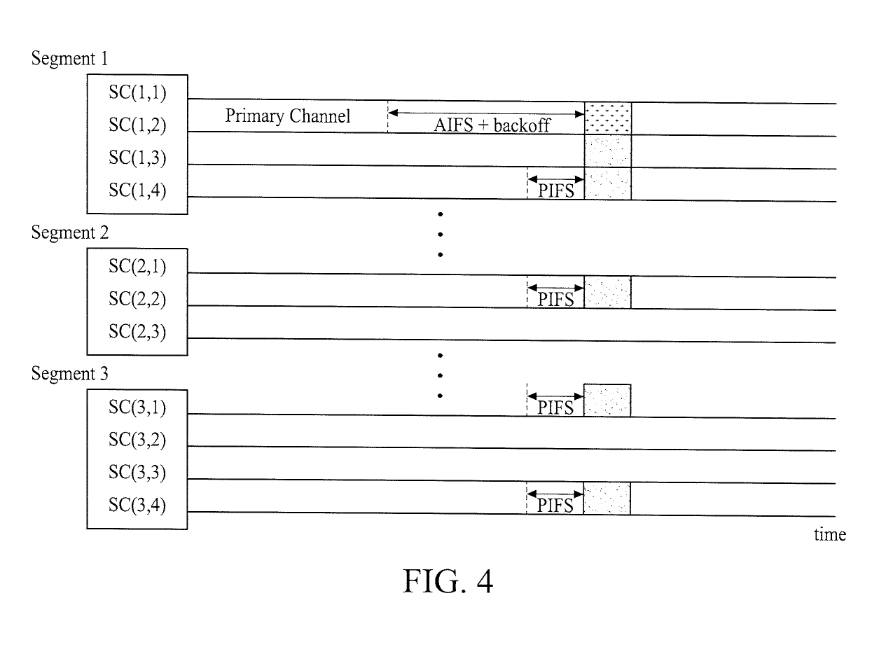

FIG. 4 shows the operation of dynamic channel selection according to the communication system shown in FIG. 2. As shown in FIG. 4, the duration of the first idle time is the sum of a duration of an arbitration inter frame space (AIFS) and a duration of a back-off time, and he duration of the second idle time is the duration of a point coordinate function (PCF) inter frame space (PIFS). In addition, the duration of the first idle time is longer than the duration of the second idle time. If all of the available channels are idle for the specified duration, the transmitted signal bandwidth is 120 MHz. If channel SC(1,2) is not idle for the duration of AIFS and a duration of a back-off time, the transmission is deferred. If channel SC(1,3) is not idle for the duration of PIFS, the signal transmission is deferred because channel SC(1,3) is at the same frequency segment as the primary channel SC(1,2). If channel SC(2,2) is not idle for the duration of PIFS and other channels are idle for the specified duration, segment 2 is exempt from transmission and the resulting signal bandwidth is 100 MHz. The same applies to channels SC(3,1) and SC(3,4). If channel SC(2,2) is to not idle for the duration of PIFS and at least one of the channels SC(3,1) and SC(3,4) is not idle for the duration of PIFS, segments 2 and 3 are exempt from transmission. As a result, only segment 1 is used for this particular transmission and the resulting signal bandwidth is 60 MHz.

In conclusion, the method for multi-channel transmission with multiple frequency segments provided by the present invention can be applied to a communication system of which not all the channels in a frequency segment are available for data transmission. Therefore, multi-channel transmission can be performed accordingly.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for multi-channel transmission with multiple frequency segments, comprising the steps of:
determining a plurality of non-contiguous frequency segments from an available frequency band of a communication system, wherein each frequency segment comprises a plurality of contiguous channels;
determining available channels from the channels in the plurality of non-contiguous frequency segments, wherein the number of available channels is less than or equal to the number of total channels in the plurality of non-contiguous frequency segments;
determining a primary channel from the available channels;
performing a channel bonding technique on the available channels; and
performing multi-channel transmission by performing dynamic is channel selection technique on the available channels.

2. The method of claim 1, wherein the number of available channels is less than the number of the total channels in the plurality of non-contiguous frequency segments.

3. The method of claim 1, wherein the step of performing multi-channel transmission comprises the sub-steps of:
deferring the multi-channel transmission if an idle duration of the primary channel is less than a first idle time;
deferring the multi-channel transmission if an idle duration of any other channel in the frequency segment containing the primary channel is less than a second idle time; and
exempting the multi-channel transmission of a frequency segment other than the frequency segment containing the primary channel if an idle duration of a channel in the frequency segment is less than a second idle time.

4. The method of claim 3, wherein the duration of the first idle time is longer than the duration of the second idle time.

5. The method of claim 3, wherein the duration of the first idle time is the sum of a duration of an arbitration inter frame space (AIFS) and a duration of a back-off time.

6. The method of claim 3, wherein the duration of the second idle time is the duration of a point coordinate function (PCF) inter frame space (PIFS).

7. The method of claim 1, wherein the bandwidth of each channel is 20 MHz.

8. The method of claim 1, wherein the bandwidth of each frequency segment is more than 40 MHz.

9. A method for multi-channel transmission with multiple frequency segments, comprising the steps of:
evaluating status of a plurality of available channels, wherein the plurality of available channels are grouped in different non-contiguous frequency segments, and the number of available channels is less than or equal to the number of total channels contained in the non-contiguous frequency segments;
performing multi-channel transmission by performing dynamic channel selection technique on the available channels;
deferring the multi-channel transmission if an idle duration of the primary channel is less than a first idle time;
deferring the multi-channel transmission if an idle duration of any other channel in the frequency segment containing the primary channel is less than a second idle time; and
exempting the multi-channel transmission of a frequency segment other than the frequency segment containing the primary channel if an idle duration of a channel in the frequency segment is less than a second idle time.

10. The method of claim 9, wherein the number of available channels is less than the number of total channels contained in the non-contiguous frequency segments.

11. The method of claim 9, wherein the duration of the first idle time is longer than the duration of the second idle time.

12. The method of claim 9, wherein the duration of the first idle time is the sum of a duration of an arbitration inter frame space (AIFS) and a duration of a back-off time.

13. The method of claim 9, wherein the duration of the second idle time is the duration of a point coordinate function (PCF) inter frame space (PIFS).

14. The method of claim 9, wherein the bandwidth of each channel is 20 MHz.

15. The method of claim 9, wherein the bandwidth of each frequency segment is more than 40 MHz.
